(19) United States
(12) Patent Application Publication
(10) Pub. No.: US 2005/0198805 A1
(43) Pub. Date: Sep. 15, 2005

(54) Method of manufacturing coupling element

(75) Inventors: Hiromichi Komori, Gunma-ken (JP); Kiyoshi Sadakata, Gunma-ken (JP)

Correspondence Address: MILES & STOCKBRIDGE PC, 1751 PINNACLE DRIVE, SUITE 500, MCLEAN, VA, 22102-3833, US

(73) Assignee: NSK Ltd.

(21) Appl. No.: 11/071,297

(22) Filed: Mar. 4, 2005

Related U.S. Application Data
(63) Continuation-in-part of application No. 09/904,908, filed on Jul. 16, 2001.

(30) Foreign Application Priority Data
Jul. 18, 2000 (JP) 2000-217649

(51) Int. Cl. B62D 5/04; B23P 11/02

(52) U.S. Cl. 29/451; 29/450

(57) ABSTRACT

A method of manufacturing a coupling element which is formed by interposing between a joint member and a hollow shaft member an elastic member for flexing and deforming upon a relative rotation between these members and forming stopper portions for restricting the relative rotation within a predetermined amount respectively on the joint member and the hollow shaft member. The method comprises the step of forming the or each stopper portion on the hollow shaft member by flaring an end of the hollow shaft member to form a flange while applying a pressing force in the axial direction onto the hollow shaft member, and then bending and raising the or each stopper portion on to increase the thickness of the root portion of the or each stopper portion such that it is greater than the thickness of the remainder of the flange.

This application claims the benefit of Japanese Patent Application No. 2000-217649 which is hereby incorporated by reference.

### BACKGROUND OF THE INVENTION

1. Field of the Invention

The present invention relates to a method of manufacturing a coupling element of an elastic shaft coupling which is used in a steering apparatus, or the like, of a car, and, more particularly, to a technology for reducing the weight or the manufacturing cost of the coupling while maintaining a sufficient strength of a stopper portion.

2. Related Background Art

A steering apparatus of a car, or the like, is comprised of a steering wheel to be used for steering operation of the driver, a steering gear for steering the wheels of the car, and a steering shaft used for coupling the steering wheel and the steering gear. Then, in the steering apparatus of a car, the steering gear is seldom positioned on the center axial line of the steering wheel, so that a plurality of steering shafts which are coupled to each other by universal joints are often used. As the universal joint for the steering shafts, a Cardan joint having a cross piece (cross shaft) which is inserted between a pair of coupling elements to be rockable is generally used, as disclosed in the U.S. Pat. No. 3,501,928.

Recently, in order to reduce transmission of kickback, or the like, from a road surface to the steering wheel, an elastic shaft coupling which employs an elastic member such as synthetic rubber is proposed, as in the Japanese Patent Application Laid-Open No. 10-89373. In an elastic shaft coupling of this type, one of the coupling elements of the Cardan joint is divided into a joint member (i.e., a yoke) and a shaft, and an elastic ring formed of synthetic rubber, or the like, is inserted between the yoke and the shaft. In order to prevent damage, or to improve the durability of the elastic ring, a stopper portion for restricting a relative rotation within a predetermined amount is formed between the yoke and the shaft.

Incidentally, in the elastic shaft coupling described above, if a so-called stopper strike is repeatedly brought about due to a load of a large torque, it is required to prevent deformation or damage of the joint member or the stopper portion of the shaft, which does not become a significant problem since the yoke is normally formed by pressing or forging from a steel plate, or the like, having a comparatively large thickness. However, the size of the shaft is inevitably reduced since the shaft is normally set inside a yoke member. As a result, it becomes difficult to maintain the strength of the stopper portion.

For this reason, though the shaft may be formed by a multiple stage forming machine from a carbon steel bar having a comparatively high hardness, there arises a problem in this case that the manufacturing cost of the shaft is increased due to a large size of the forming machine or an increased number of forming molds. For instance, in order to form an elongated shaft by a forming machine, a comparatively large metal mold is required. However, in this case, the metal mold can not be installed unless the forming machine is of a large size. For this reason, when the length of the shaft is 100 mm or more, there may be a case in which the existing forming machine can not be used for the processing so that a large-sized forming machine has to be introduced inevitably.

If the stopper portion and the shaft have the same diameter size, the forming machine requires a metal mold corresponding to the total length of the shaft, so that a large number of metal molds are required to be manufactured when a large kinds of products are to be produced on a small-lot basis. As a result, the unit cost of a small-lot products inevitably exceeds an allowed range if the production cost of such molds is included. Further, when a collapsible mechanism against a secondary collision by a driver is provided in a coupling element, as disclosed in the Japanese Patent Application Laid-Open No. 8-91230, the shaft is formed in the shape of a pipe so that the steering shaft can advance into the shaft. However, the processing therefor requires a large number of steps, thereby increasing the manufacturing cost of the shaft.

On the other hand, it is possible to employ a cold forging and pressing treatment which has less restrictions with respect to the size or the material of the shaft. However, in this case, an annealing step is required for softening a work which has been treated and hardened for each main forming step, so that the productivity drastically declines to inevitably increase the manufacturing cost, also.

### SUMMARY OF THE INVENTION

The present invention was contrived taking the above circumstances into consideration, and an object of the invention is to provide a manufacturing method of a coupling element of an elastic shaft coupling, which realizes reduction of the manufacturing cost while maintaining a sufficient strength of the coupling.

In order to solve the above problems, according to the present invention, there is proposed a method of manufacturing a coupling element which is formed by interposing between a joint member and a hollow shaft member an elastic member for flexing and deforming upon a relative rotation between these members and forming stopper portions for restricting the relative rotation within a predetermined amount respectively on the joint member and the hollow shaft member, comprising the step of:
forming the or each stopper portion on said hollow shaft member by flaring an end of the hollow shaft member to form a flange while applying a pressing force in the axial direction onto said hollow shaft member, and then bending and raising the or each stopper portion to increase the thickness of the root portion of the or each stopper portion such that it is greater than the thickness of the remainder of the flange.

In the method of the present invention said hollow shaft member may be low carbon steel pipe.

### BRIEF DESCRIPTION OF THE DRAWINGS

FIG. 1 is a side view of a Cardan joint adopting a coupling element according to a first embodiment of the present invention.

FIG. 2 is a cross sectional view, taken along line A-A in FIG. 1.

FIG. 3 is a longitudinal cross sectional view for showing a material of a hollow shaft.

FIG. 4 is a longitudinal cross sectional view for showing a preliminary forming step of a stopper portion. FIGS. 4A-4C show steps of a further method for forming a stopper of the hollow shaft to be used for the first embodiment. FIGS. 4D and 4E show steps of another method for forming a stopper of the hollow shaft to be used for the first embodiment.

FIG. 5 is a longitudinal cross sectional view for showing a completed state of the stopper portion.

FIG. 5A is a longitudinal cross sectional view for showing a similar state to FIG. 5 of a modified example of the hollow shaft.

FIG. 5B is a longitudinal cross sectional view for showing a similar state to FIG. 5 of a second modified example of the hollow shaft.

FIG. 6 is an explanatory view for showing an operation at a stopper strike according to the first embodiment.

FIG. 7 is a cross sectional view for showing a yoke assembly according to a second embodiment of the present invention.

FIG. 8 is a cross sectional view for showing the yoke assembly according to the second embodiment of the present invention.

FIG. 9 is a cross sectional view for showing a yoke assembly according to a third embodiment of the present invention.

FIG. 10 is a cross sectional view for showing the yoke assembly according to the third embodiment of the present invention.

FIG. 11 is a side view (cross sectional view) for showing a yoke assembly according to a fourth embodiment of the present invention.

FIG. 12 is a cross sectional view, taken along line B-B in FIG. 11, in the normal condition.

FIG. 13 is a cross sectional view, taken along line B-B in FIG. 11, at the stopper strike.

### DETAILED DESCRIPTION OF THE PREFERRED EMBODIMENTS

An elastic shaft coupling adopting a coupling element manufactured according to the present inventive method will be described by way of several embodiments.

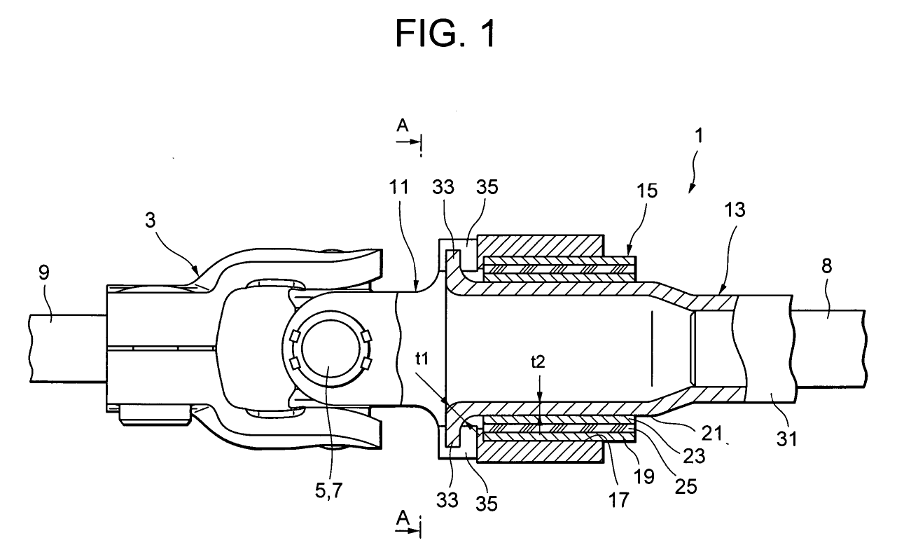

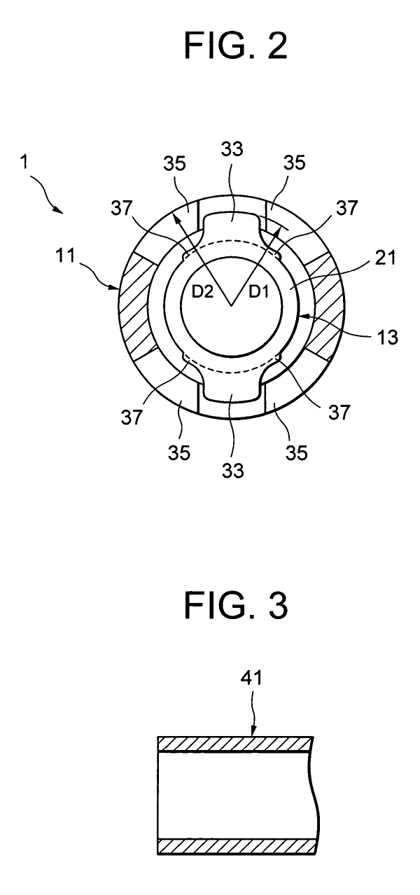

FIG. 1 is a side view, partially in cross section, of a Cardan joint in which an elastic shaft coupling (yoke assembly) according to a first embodiment is assembled, while FIG. 2 is a cross sectional view taken along line A-A in FIG. 1. As shown in FIG. 1, the Cardan joint is composed of a yoke assembly 1 according to the present invention, a partner yoke 3, a cross joint 5, and a bearing (needle roller bearing) 7, so as to couple the first steering shaft 8 and the second steering shaft 9 to each other to be freely rockable.

The yoke assembly 1 comprises a yoke 11 which is formed by deep drawing and pressing using a hot rolled steel plate, or the like, as its material, a shaft 13 formed of a low carbon steel pipe by pressing, and an elastic ring 15 which is interposed between the yoke 11 and the shaft 13. The elastic ring 15 comprises an outer sleeve 19 which is press-fitted in a core hole 17 of the yoke 11, an inner sleeve 23 in which a front tube portion 21 of the shaft 13 is press-fitted, and a synthetic rubber 25 which is filled and vulcanizing-bonded between the outer sleeve 19 and the inner sleeve 23. The synthetic rubber 25 is flexed and deformed upon a relative rotation between the yoke 11 and the shaft 13.

The shaft 13 is composed of a front tube portion 21 having a comparatively large diameter, a rear tube portion 31 having a comparatively small diameter, and a pair of stopper portions 33 formed at the tip end of the front tube portion 21. The stopper portions 33 are bent and raised each into the form of a flange at an interval of 180° from the front tube portion 21, so as to face stopper portions 35 of the partner yoke 3 with a predetermined gap therebetween. In this case, a pair of stopper portions may be bent and raised once each to have the entire circumference in the form of a flange and then trimmed into the form of a stopper. Each of the stopper portions 33 is formed to have at the end portion thereof reinforcement ribs 37 which are provided on the base portion along the circumferential direction, and has an outer diameter D1 which is significantly smaller than the outer diameter D2 of the stopper portion 35 of the partner yoke 3.

The stopper portion 33 is formed such that the thickness t1 of the portion (root portion) continuing to the front tube portion 21 is substantially larger than the thickness t2 of the front tube portion 21.

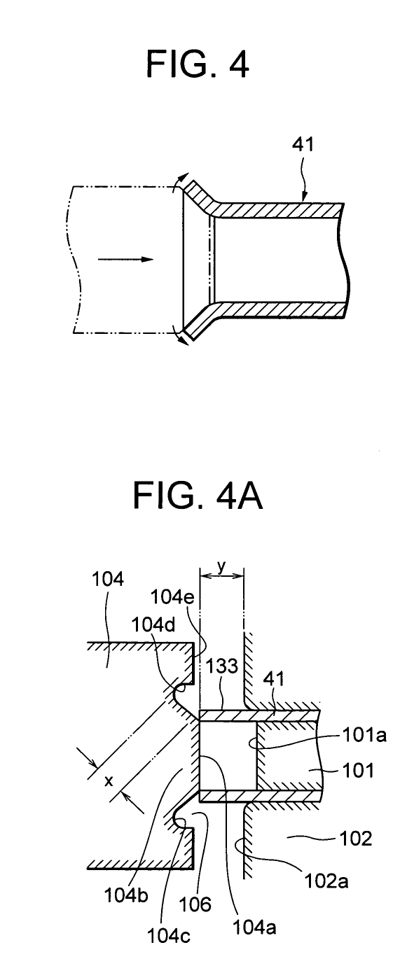

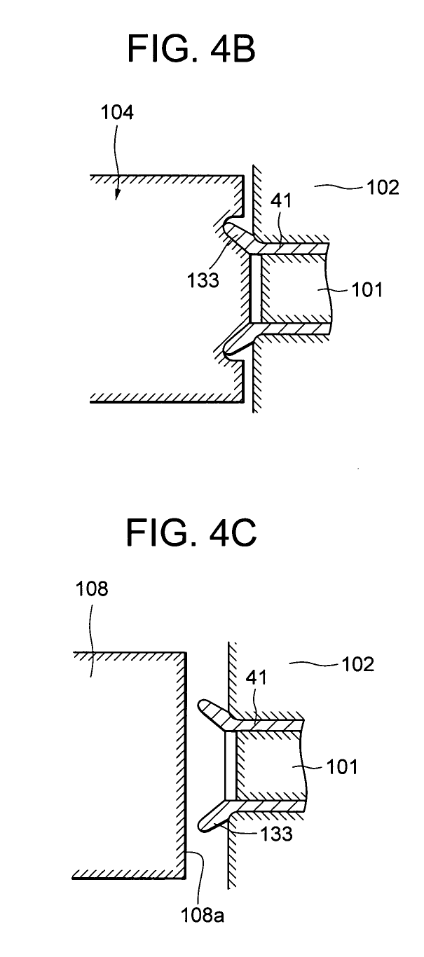

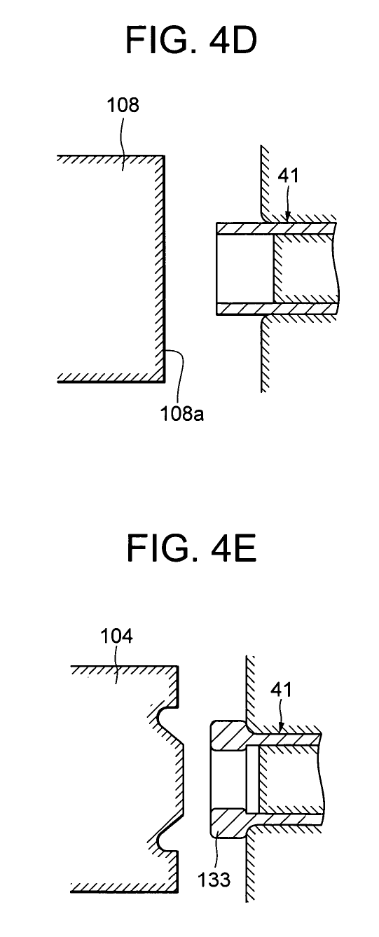

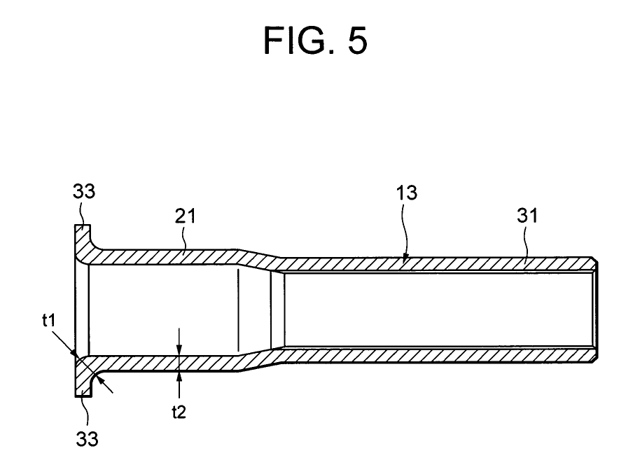

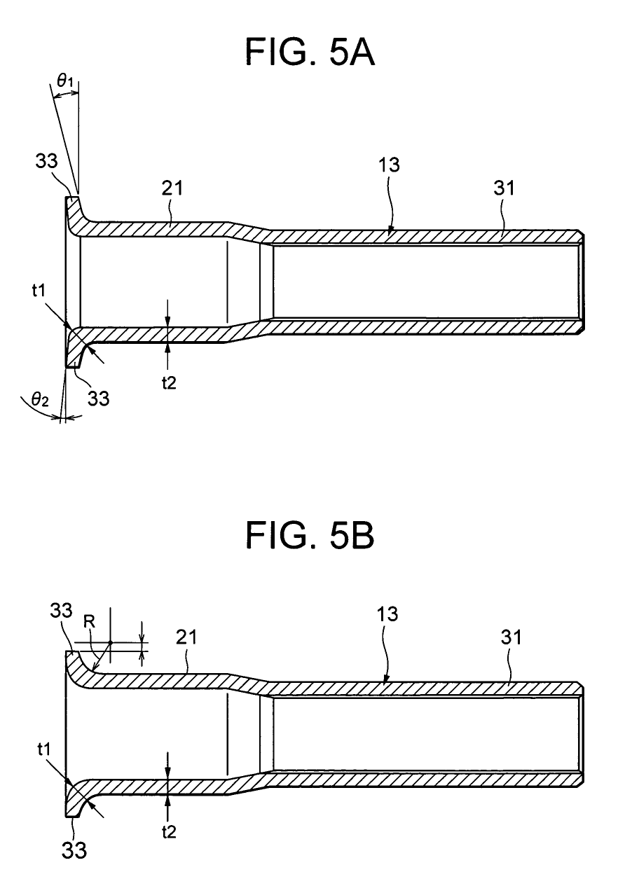

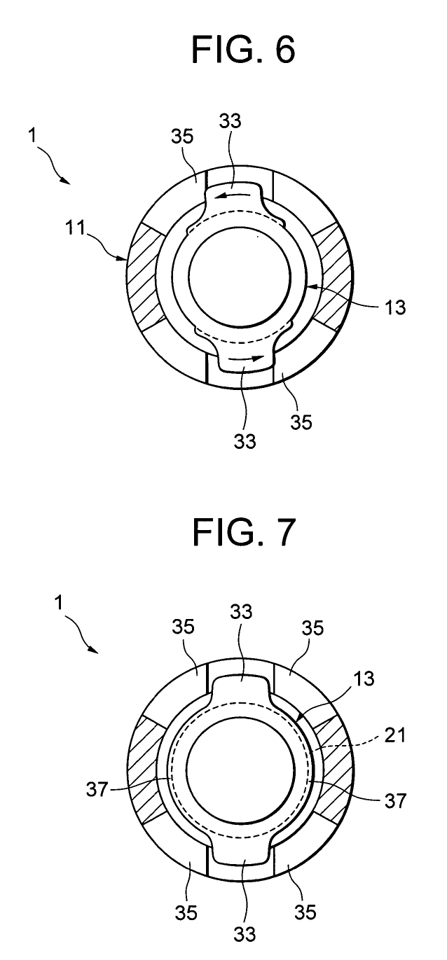

In case of the present embodiment, in order to increase the thickness of the root portion, the following steps are conducted. That is, a preliminary forming is conducted to the material (low carbon steel pipe) 41 shown in FIG. 3 while applying a pressing force in the axial direction, as shown in FIG. 4. After that, as shown in FIG. 5, the stopper portion 33 is bent and raised up, whereby the material is crushed at the root of the stopper portion 33. As a result, the thickness t1 of this portion is substantially larger than the thickness which is obtained simply by bending and raising of the material.

Next, several further methods for forming the stopper portions 33 having the increased thickness t1 at the root portion as last described, will be explained in detail.

FIGS. 4A-4C show steps for forming the shaft 13 as shown in FIG. 5 from a low carbon steel pipe material 41, as an example of those further methods.

As shown in FIG. 4A, the low carbon steel pipe 41 is set in an annular space formed between an inner guide 101 and an outer guide 102 of a guide apparatus. An end face 101a of the inner guide 101 and an end face 102a of the outer guide 102 are both flat and extended vertically in the drawings. The end face 102a of the outer guide 102 is located slightly more left side than the end face 101a of the inner guide 101. The outer guide 102 may be composed of an upper and lower halves in order to make setting of the pipe material 41 in the guide apparatus easier.

At first, the pipe material 41 is so set in the guide apparatus that a predetermined length y of one end of the pipe material 41 may be projected from the end face 102a of the outer guide 102, taking the size of the stopper portions 33 of the desired shaft into account, as shown in FIG. 4A. The guide apparatus is so structured that a pipe material may be set in such a position, although not shown in detail.

Next, a punch 104 shown in FIG. 4A is urged to move rightward to press the left end face of the pipe material 41 set in between the inner and outer guides 101 and 102. The punch 104 is formed at an end thereof, with an annular groove 106 for forming a central truncated conical projection 104b which has a central circular portion 104a having slightly smaller diameter than that of the inner diameter of the pipe material 41 and a conical surface diverged from the periphery of the central circular portion 104a toward the bottom of the annular groove 106. An outer diameter side surface 104d of the annular groove 106 is steeply raised from the bottom of the groove 106 and preferably diverged outward. An end face 104e of the punch 104 at an outer side of the annular groove 106 is a flat surface extended vertically which forms an abutment surface against the end face 102a of the outer guide 102. A distance x from the groove bottom 104c as a proximal end of the conical projection to a plane of the abutment surface 104e has a relation x<y with respect to the length y of the projected end portion 133 of the pipe material 41 from the end face 102a of the outer guide 102 in the state where the pipe material 41 is set in the guide apparatus as above described.

After setting the pipe material 41 in the guide apparatus, the punch 104 is moved rightward from the state shown in FIG. 4A, thereby flaring the left end projection 133 of the pipe material 41 along the conical surface of the conical projection 104b, as shown in FIG. 4B. The flaring may be effected by a single step, or by a plurality of steps so that the pipe end may be flared gradually.

Upon completion of the flaring by the punch 104, a second punch 108 is used to press the leftward projection 133 of the pipe material 41, thereby deforming the projection 133. The second punch 108 has a punching surface 108a which is flat entirely and extended vertically.

The punch 108 is moved toward the guide apparatus to bend and raise up the flared or diameter enlarged projected portion 133 so that the entire circumference in the form of a flange, as shown in FIG. 5 may be formed, and then may be trimmed into the form of a stopper.

Some modifications of the process for forming the stopper portion of the pipe 13 will be explained.

As a first modification, a plurality of punches differing in inclination angles of conical surfaces forming the truncated conical projection, are used to flare gradually the projected portion 133 of the pipe material 41.

A second modification is shown in FIGS. 4D and 4E, in which a pipe material 41 is set in a predetermined state, and then an abutment surface 108a which is flat, as shown in FIG. 4D, is abutted against an end of the pipe material 41, thereby increasing the thickness of the projected portion 133 of the pipe material 41, as shown in FIG. 4E.

Then, a similar punch 104 as that shown in FIGS. 4A and 4B is used to bend and raise the entire circumference of the projected portion 133 up into the form of a flange, then trimming into the form of a stopper.

As a third modification, a pipe material set in the guide apparatus is held fixedly, and a punch is moved toward the guide apparatus, while rotating, thereby enlarging the diameter of the entire circumference of the projected portion of the pipe material to be flared into the form of an flange and then trimming into the form of a stopper portion. Alternatively, a punch may be held fixedly, while rotating the pipe material, to form a stopper portion.

In all the above further methods for forming the stopper portion, the entire circumference of the projected portion of the pipe material is bent and raised up in the form of a flange and then trimmed into the form of a stopper.

Instead of such methods, the projected tubular portion of the pipe material is first trimmed to have two projections at an interval 1800. Then, the two projections are bent and raised up by any of the similar methods as described above.

In the flange forming steps as described above, a pipe material may be processed using an outer guide 102 which is formed with a conical surface from an inner diametral edge of an end face 102a to an inner peripheral surface, and/or using a punch 104 formed with a conical surface on the central truncated conical projection 104a, to form flange portions 33, as shown in FIG. 5A, each having a conical surface of an angle θ1 with respect to a plane perpendicular to the axis of the pipe 13 at an outer surface side of the flange portion 33, and a conical surface of an angle θ2 with respect to a plane perpendicular to the axis of the pipe 13 at an inner diameter side of the flange portion 33. According to such process for flaring the pipe, the pipe material is hard to be cracked during flaring step(s), so a hard steel pipe material containing a relatively large amount of carbon can be processed.

Further, an outer guide 102 which has an arcuate cross-section of radius R from the inner diametral end of an end face to the inner peripheral portion, may be used to form a flange portion of a pipe, as shown in FIG. 5B, so that the center of the radius R of the cross section of the flange portion may be located at an outer side than the outer periphery of the flange portion. According to such process for flaring the pipe also, the pipe material is hard to be cracked during flaring step(s), so a hard steel pipe material containing a relatively large amount of carbon can be processed.

Description will be made below of a mode of operation of the first embodiment.

When the driver conducts a steering operation while driving or receives a kickback supplied from the road surface, a relative rotation is generated between the yoke assembly 1 and the partner yoke 3 due to a rotational reacting force in the Cardan joint. Then, when this relative rotation is small, the synthetic rubber 25 of the elastic ring 15 is flexed and deformed, so as to prevent unpleasant shimmy or shock from being transmitted to the hand of the driver. However, when an amount of the relative rotation exceeds a predetermined value in a sudden steering operation, or the like, the stopper portions 33 on the shaft 13 and the stopper portions 35 on the yoke 11 cause a so-called stopper strike, thereby preventing damage to the elastic ring 15 (synthetic rubber 25) due to an excessive flexion or deformation, or reduction of the durability thereof.

In this case, a shearing stress is applied on the stopper portions 33 on the shaft 13 side. However, for the stopper portions 33 of the present embodiment, the reinforcement ribs 37 are formed at the base portion thereof, the outer diameter D1 is formed small, and the thickness t1 of the root portion is formed large. As a result, the strength of the base portion at which the stress is liable to concentrate is formed significantly higher than that of a conventional one, whereby damage or deformation hardly occur. Moreover, since being formed of a comparatively light steel pipe, the shaft 13 can be made remarkably lighter at a far lower cost than a shaft produced by the conventional forming machine. In addition, it is no longer required to form a hole through which the steering shaft 8 is to be passed.

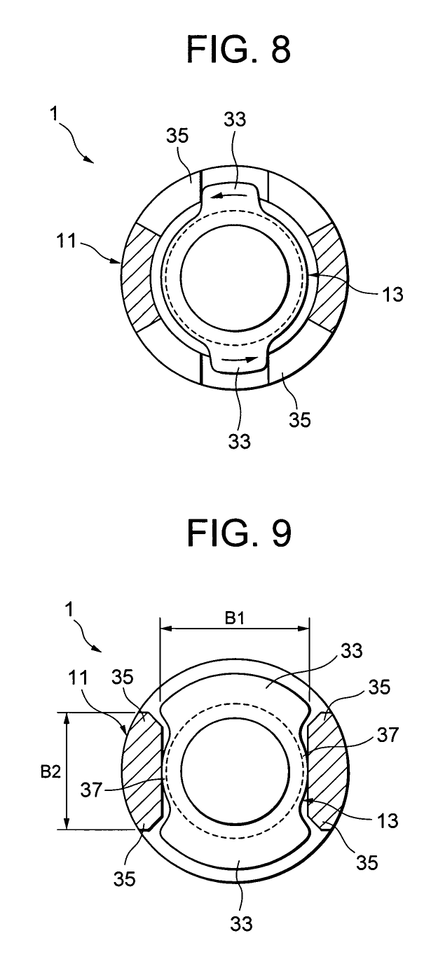

FIG. 7 and FIG. 8 are cross sectional views for showing a yoke assembly 1 according to a second embodiment of the present invention, in which FIG. 7 shows the yoke assembly 1 in the normal state, while FIG. 8 shows the state at a stopper strike. The entire structure of the second embodiment and the mode of operation thereof are substantially the same as those of the first embodiment described above, except that the reinforcement ribs 37 are disposed along the entire circumference of the yoke assembly and the strength of the stopper portion 33 is further enhanced.

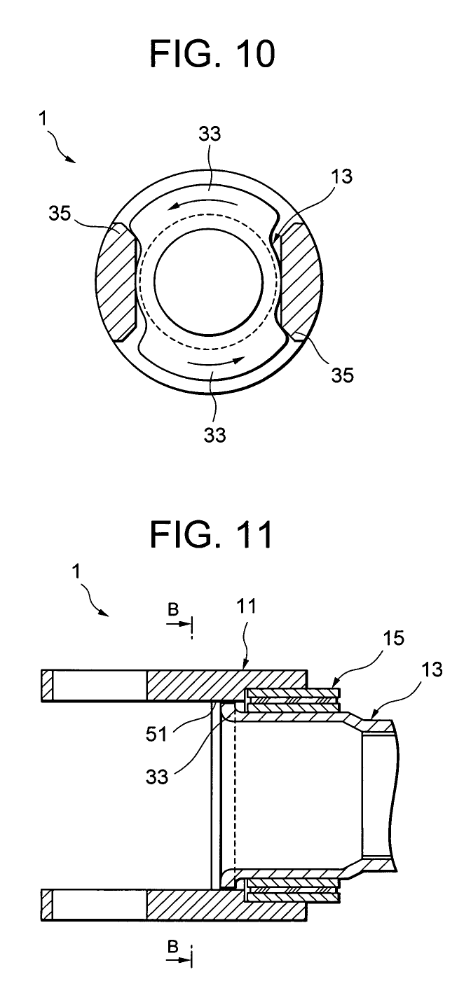

FIG. 9 and FIG. 10 are cross sectional views for showing a yoke assembly 1 according to a third embodiment of the present invention, in which FIG. 9 shows the yoke assembly 1 in the normal state, while FIG. 10 shows the state at a stopper strike. The entire structure of the third embodiment and the mode of operation thereof are substantially the same as those of the second embodiment described above, except that the breadth B1 of the stopper portion 33 on the shaft 13 side is larger than the breadth B2 of the stopper portion 35 on the yoke 11 side, so that the strength of the stopper portion 33 is further enhanced.

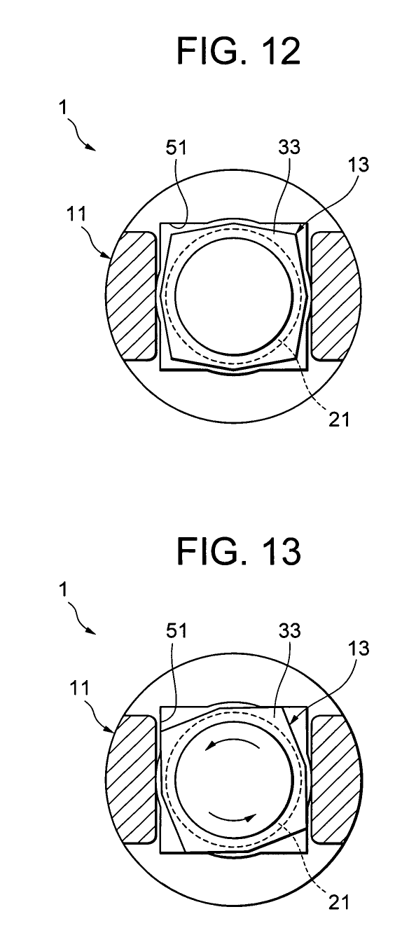

FIG. 11 is a longitudinal cross sectional view for showing a yoke assembly 1 according to a fourth embodiment of the present invention, and FIG. 12 and FIG. 13 are cross sectional views taken along the line B-B in FIG. 11 corresponding to the normal state and the state at a stopper strike. The entire structure of the fourth embodiment and the mode of operation thereof are substantially the same as those of the foregoing embodiments, except that a stopper hole 51 having a substantially square shape is formed on the yoke 11 while a stopper portion 33 having a deformed octagonal shape is formed on the shaft 13 to be corresponding to this stopper hole 51.

As described above, in each of the foregoing embodiments, it is possible to form the stopper portions 33 having the high strength while employing a comparatively light and inexpensive low carbon steel pipe as a material for the shaft 13, whereby the durability of the yoke assembly 1 can be enhanced and the weight and the cost thereof can be reduced.

Though the specific description of the embodiments are completed as above, the present invention is not limited to these embodiments. For instance, in the foregoing embodiments, the present invention is applied to a Cardan joint. However, the present invention may be applied to a double Cardan joint, a bar field joint, or the like. In addition, the form of the stopper portion or the structure of the elastic ring may properly varied and modified within the scope and spirit of the present invention.

As described above, the elastic shaft coupling according to the present invention has a coupling element which is formed by interposing between a joint member and a hollow shaft member an elastic member for flexing and deforming upon a relative rotation between these two members and forming stopper portions for restricting the relative rotation within a predetermined amount respectively on the joint member and the hollow shaft member. In this case, the stopper portions on the hollow shaft member side are formed by plastically processing the end portion of the material of the hollow shaft member into a flange shape, so that it is possible to reduce the weight and the manufacturing cost of the coupling while maintaining the sufficient durability thereof.

1. A method of manufacturing a coupling element which is formed by interposing between a joint member and a hollow shaft member an elastic member for flexing and deforming upon a relative rotation between these members and forming stopper portions for restricting the relative rotation within a predetermined amount respectively on the joint member and the hollow shaft member, comprising the step of:
forming the or each stopper portion on said hollow shaft member by flaring an end of the hollow shaft member to form a flange while applying a pressing force in the axial direction onto said hollow shaft member, and then bending and raising the or each stopper portion to increase the thickness of the root portion of the or each stopper portion such that it is greater than the thickness of the remainder of the flange.

2. A method according to claim 1, wherein said hollow shaft member is a low carbon steel pipe.

3. A method according to claim 1, wherein in the stopper forming step the pressing force in the axial direction is applied while at least one of the hollow shaft member and a punch for applying the pressing force being rotated.
